(19) United States
(12) Patent Application Publication
(10) Pub. No.: US 2024/0316453 A1
(43) Pub. Date: Sep. 26, 2024

(54) INFORMATION PROCESSING METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Xiaofeng CHEN, Shenzhen (CN); Yuanyuan Pei, Shenzhen (CN); Yun Ai, Shenzhen (CN); Xingqi Zhou, Shenzhen (CN)

(21) Appl. No.: 18/676,246

(22) Filed: May 28, 2024

Related U.S. Application Data
(63) Continuation of application No. PCT/CN2023/090764, filed on Apr. 26, 2023.

(30) Foreign Application Priority Data
Jul. 21, 2022 (CN) 202210860284.6

(51) Int. Cl. A63F 13/42

(52) U.S. Cl. CPC A63F 13/42

(57) ABSTRACT

This application discloses an information processing method performed by an electronic device. The method includes: obtaining a current location of a first virtual character in a scene of a virtual game while the first virtual character participates in a current game task of the virtual game under control by a client; determining that the current location matches a virtual vehicle provided by the current game task; and displaying a virtual projection corresponding to a second virtual character that meets a projection condition among virtual characters participating in the virtual game. This application resolves a technical problem of low information display efficiency.

### CROSS-REFERENCE TO RELATED APPLICATIONS

This application is a continuation application of PCT Patent Application No. PCT/CN2023/090764, entitled “INFORMATION PROCESSING METHOD AND APPARATUS, STORAGE MEDIUM, AND ELECTRONIC DEVICE” filed on Apr. 26, 2023, which claims priority to Chinese Patent Application No. 202210860284.6, entitled “INFORMATION PROCESSING METHOD AND APPARATUS, STORAGE MEDIUM, AND ELECTRONIC DEVICE” filed on Jul. 21, 2022, both of which are incorporated by reference in their entirety.

### FIELD OF THE TECHNOLOGY

This application relates to the field of computers, and specifically to information processing technologies.

### BACKGROUND OF THE DISCLOSURE

In a scene of a virtual game, information can be displayed in various manners. For example, information related to a virtual character may be displayed in a manner of a virtual projection. However, the display of the virtual projection is usually fixed in the related technology. A user needs to move to a fixed location for displaying the virtual projection to view the virtual projection. This is relatively passive and inflexible, causing low information display efficiency.

### SUMMARY

Embodiments of this application provide an information processing method and apparatus, a storage medium, and an electronic device, to resolve at least the technical problem of low information display efficiency.

According to one aspect of the embodiments of this application, an information processing method is performed by an electronic device and the method including: obtaining a current location of a first virtual character in a scene of a virtual game while the first virtual character participates in a current game task of the virtual game under control by a client; determining that the current location matches a virtual vehicle provided by the current game task; and displaying a virtual projection corresponding to a second virtual character that meets a projection condition among virtual characters participating in the virtual game.

According to still another aspect of the embodiments of this application, an electronic device is further provided, including a memory, a processor, and a computer program stored on the memory that, when executed by the processor, causes the electronic device to perform the information processing method described above through the computer program.

According to still another aspect of the embodiments of this application, a non-transitory computer-readable storage medium is provided, including a stored computer program, the computer program, when run by an electronic device, causing the electronic device to perform the information processing method described above.

In the embodiments of this application, in a running process that a first virtual character participates in a current game task, a current location of the first virtual character in a scene of a virtual game is obtained, the first virtual character being a virtual character controlled by a client, and the current game task being a task in the virtual game; and a virtual projection corresponding to a second virtual character is displayed if it is determined that the current location is in a virtual mobile device provided by the current game task, the second virtual character being a virtual character that meets a projection condition among virtual characters participating in the virtual game. The current location of the virtual character current in the scene of the virtual game is identified to determine whether the virtual character matches the virtual mobile device, and the display of the virtual projection is further triggered by using the virtual mobile device further to provides a user with a manner of proactively triggering the display of a virtual projection. In this way, the virtual projection can be flexibly displayed, so that the technical effect of improving information display efficiency is achieved, thereby resolving the technical problem of low information display efficiency.

### BRIEF DESCRIPTION OF THE DRAWINGS

The accompanying drawings described herein are used to provide a further understanding of this application, and form part of this application. Exemplary embodiments of this application and descriptions thereof are used to explain this application, and do not constitute any inappropriate limitation to this application. In the accompanying drawings:

FIG. 1 is a schematic diagram of an application environment of an information processing method according to an embodiment of this application.

FIG. 2 is a schematic flowchart of an information processing method according to an embodiment of this application.

FIG. 3 is a schematic diagram of an information processing method according to an embodiment of this application.

FIG. 4 is a schematic diagram of another information processing method according to an embodiment of this application.

FIG. 5 is a schematic diagram of another information processing method according to an embodiment of this application.

FIG. 6 is a schematic diagram of another information processing method according to an embodiment of this application.

FIG. 7 is a schematic diagram of another information processing method according to an embodiment of this application.

FIG. 8 is a schematic diagram of another information processing method according to an embodiment of this application.

FIG. 9 is a schematic diagram of another information processing method according to an embodiment of this application.

FIG. 10 is a schematic diagram of another information processing method according to an embodiment of this application.

FIG. 11 is a schematic diagram of another information processing method according to an embodiment of this application.

FIG. 12 is a schematic diagram of another information processing method according to an embodiment of this application.

FIG. 13 is a schematic diagram of another information processing method according to an embodiment of this application.

FIG. 14 is a schematic diagram of another information processing method according to an embodiment of this application.

FIG. 15 is a schematic diagram of another information processing method according to an embodiment of this application.

FIG. 16 is a schematic diagram of an information processing apparatus according to an embodiment of this application.

FIG. 17 is a schematic structural diagram of an electronic device according to an embodiment of this application.

### DESCRIPTION OF EMBODIMENTS

In order to make a person skilled in the art better understand the solutions of this application, the following clearly and completely describes the technical solutions in the embodiments of this application with reference to the accompanying drawings in the embodiments of this application. Apparently, the described embodiments are only some of the embodiments of this application rather than all of the embodiments. All other embodiments obtained by a person of ordinary skill in the art based on the embodiments of this application without creative efforts shall fall within the protection scope of this application.

In this specification, the claims, and the accompanying drawings of this application, the terms “first”, “second”, and so on are intended to distinguish similar objects but do not necessarily indicate a specific order or sequence. The data termed in such a way is interchangeable in proper circumstances, so that the embodiments of this application described herein can be implemented in other sequences than the sequence illustrated or described herein. Moreover, the terms “include”, “contain”, and any other variants thereof mean to cover the non-exclusive inclusion. For example, a process, method, system, product, or device that includes a list of steps or units is not necessarily limited to those steps or units that are clearly listed, but may include other steps or units not expressly listed or inherent to such a process, method, system, product, or device.

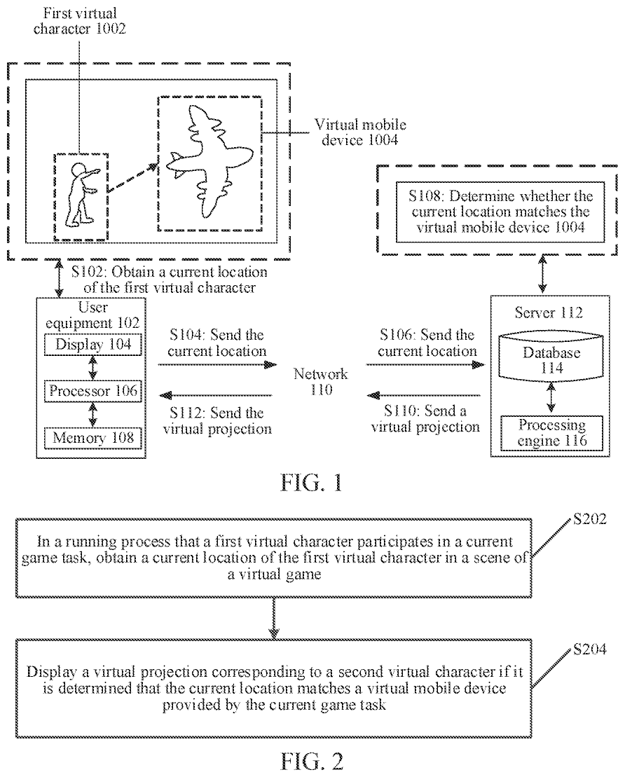

According to one aspect of the embodiments of this application, an information processing method is provided. In a possible implementation, the information processing method may be applied to, but is not limited to, an environment shown in FIG. 1. The environment may include, but is not limited to, user equipment 102 and a server 112. The user equipment 102 may include, but is not limited to, a display 108, a processor 106, and a memory 104. The server 112 includes a database 114 and a processing engine 116.

A specific process may include the following blocks:

S102: The user equipment 102 obtains a current location of a first virtual character 1002.

S104-S106: Send location information of the current location to the server 112 through a network 110.

S108: The server 112 determines, through the processing engine 116, whether the current location matches a virtual mobile device 1004, and if yes, obtains a virtual projection of a second virtual character from the database 114.

S110-S112: The server 112 sends rendering information of the virtual projection to the user equipment 102 through the network 110, and the user equipment 102 renders the virtual projection through the processor 106, displays a rendering result on the display 108, and stores the rendering information of the virtual projection in the memory 104.

In addition to the example shown in FIG. 1, the foregoing blocks may be completed with the assistance of the server. That is, the server performs the blocks of determining whether the current location matches the virtual mobile device, obtaining the virtual projection of the second virtual character, and other blocks, to reduce the processing pressure of the server. The user equipment 102 includes, but is not limited to, a handheld device (such as a mobile phone), a notebook computer, a desktop computer, an in-vehicle device, or the like. A specific implementation of the user equipment 102 is not limited in this application.

In a possible implementation, as shown in FIG. 2, the information processing method includes:

S202: In a running process that a first virtual character participates in a current game task, obtain a current location of the first virtual character in a scene of a virtual game, the first virtual character being a virtual character controlled by a client, and the current game task being a task in the virtual game.

S204: Display a virtual projection corresponding to a second virtual character if it is determined that the current location matches a virtual mobile device provided by the current game task, the second virtual character being a virtual character that meets a projection condition among virtual characters participating in the virtual game.

In a possible implementation, the information processing method may be applied to, but is not limited to, a dynamic projection of the scene of the virtual game. The dynamic projection may be, but is not limited to, a three-dimensional virtual character model with a consistent appearance presented to the virtual character. The three-dimensional virtual character model is not only a static model, but also may be, but is not limited to, a dynamic model that performs dynamic interactive actions according to preset settings.

The dynamic projection may be fixed at, but not limited to, a preset location for presentation. In such a manner, a user usually needs to move the virtual character or change a viewing angle of the screen to obtain the presentation screen of the dynamic projection. However, when the user cannot independently control the virtual character to move (for example, the virtual character controlled by the user is in a vehicle riding state, or the virtual character controlled by the user is in a controlled state), information about the dynamic projection cannot be normally transmitted. However, in this embodiment, the dynamic projection is separated, for example, when the virtual character controlled by the user is in the vehicle riding state, the dynamic projection is mounted on a component of the vehicle. In this way, the location of the dynamic projection moves with location changes of the virtual character, enabling the user to maintain the normal display of the projection information during passive movement.

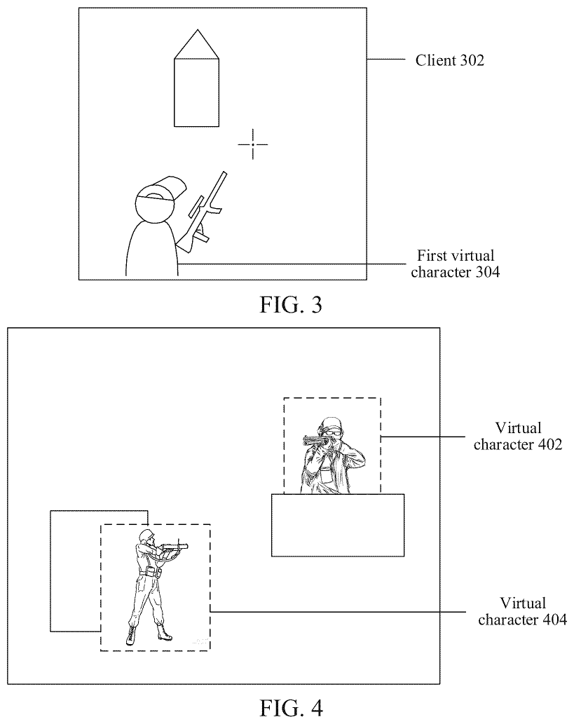

In a possible implementation, in this embodiment, the first virtual character is a virtual character controlled by the client. As shown in FIG. 3, a user of a client 302 controls a first virtual character 304 to perform an operation such as moving, attacking, or jumping in the scene of the virtual game.

In a possible implementation, in this embodiment, the current game task is a task in the virtual game. The virtual game may include, but is not limited to, a plurality of tasks. The current game task may be configured for, but not limited to, determining a battle result of the virtual game, such as determining that a camp that prioritizes the completion of the current game task wins.

By way of further example, in a possible implementation, for example, as shown in FIG. 4, the virtual game includes at least two different camps, such as a virtual character 402 of a camp A and a virtual character 404 of a camp B. In this case, the current game task may be, but is not limited to, defeating a virtual character of the opposing camp. For example, when the virtual character 402 defeats the virtual character 404, the virtual character 402 prioritizes the completion of the current game task and wins the virtual game. On the contrary, when the virtual character 404 defeats the virtual character 402, the virtual character 404 prioritizes the completion of the current game task and wins the virtual game.

The virtual mobile device may be a device that moves with the first virtual character in the virtual game. Usually, the virtual mobile device may be a virtual vehicle (such as a mobile vehicle or a control vehicle), a virtual item (such as a virtual backpack or a virtual handheld device) carried by the first virtual character, or the like.

When the virtual mobile device is a virtual vehicle, the manner of determining whether the current location matches the virtual mobile device provided by the current game task may be determining whether the current location is in the virtual vehicle. If it is determined that the current location is in the virtual vehicle, it may be determined that the current location matches the virtual mobile device.

In a possible implementation, in this embodiment, the current location is a location of the first virtual character in the scene of the virtual game currently. If the virtual mobile device is a virtual vehicle, before the first virtual character enters the virtual mobile device, the location of the first virtual character may be outside the virtual mobile device. After the first virtual character enters the virtual mobile device, the location of the first virtual character is in the virtual mobile device.

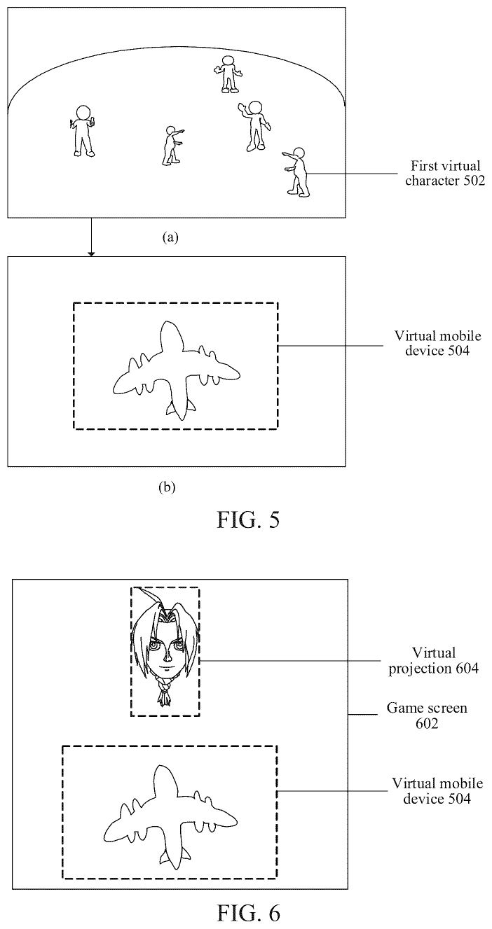

By way of further example, in a possible implementation, for example, a plurality of virtual characters participating in the current game task are first placed in an initial region, as shown by (a) in FIG. 5, the plurality of virtual characters including a first virtual character 502. Further, as shown by (b) in FIG. 5, when a preset condition (for example, a duration of stay of the virtual character in the initial region reaches a preset threshold) is reached, locations of the plurality of virtual characters are set to be in a virtual mobile device 504. In other words, the case shown by (b) in FIG. 5 is the same as the case that a current location of the first virtual character 502 is in the virtual mobile device 504 provided by the current game task.

In a possible implementation, in this embodiment, a display manner of the virtual projection may be related to, but is not limited to, a game screen presented on the client. For example, when the current location is in the virtual mobile device provided by the current game task, a third-person perspective game screen is displayed on the client, and the virtual projection is displayed in the third-person perspective game screen.

By way of further example, in a possible implementation, based on a scene shown in FIG. 5, further, as shown in FIG. 6, for example, a third-person perspective game screen 602 is displayed on the client, and the virtual mobile device 504 and a virtual projection 604 are displayed in the third-person perspective game screen 602.

In a possible implementation, in this embodiment, if the current is in the virtual mobile device provided by the current game task, a first-person perspective game screen is displayed on the client, and the virtual projection is displayed in the first-person perspective game screen.

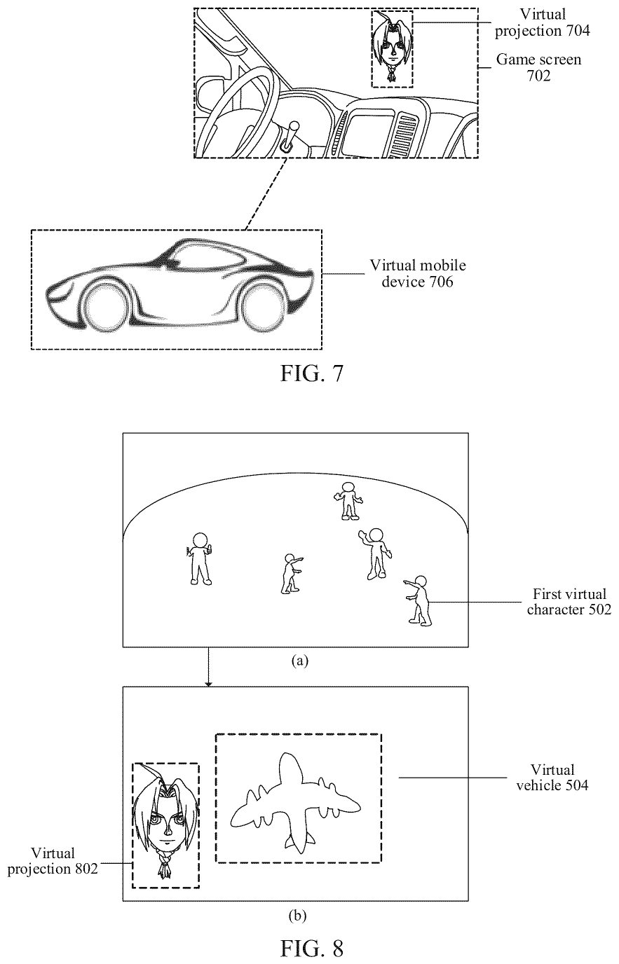

By way of further example, in a possible implementation, for example, as shown in FIG. 7, a first-person perspective game screen 702 is displayed on the client, and a virtual projection 704 and an internal scene screen of the virtual mobile device 706 are displayed in the first-person perspective game screen 702.

In a possible implementation, in this embodiment, the virtual projection may be configured with, but is not limited to, corresponding display restrictions. For example, when a display duration of the virtual projection reaches a preset duration, the display of the virtual projection is canceled. For another example, when the location of the virtual character is outside the virtual vehicle, the display of the virtual projection is canceled.

In a possible implementation, in this embodiment, the first virtual character that triggers the virtual projection may be restricted, but is not limited thereto. For example, the first virtual character is a driver or a passenger of the virtual mobile device. A display location of the virtual projection is also related to a type of use of the first virtual character in the virtual mobile device. For example, when the first virtual character is a driver and the location of the first virtual character is in the virtual mobile device, the virtual projection is displayed on a display interface associated with the driver. For another example, when the first virtual character is a passenger and the location of the first virtual character is in the virtual mobile device, the virtual projection is displayed on a display interface associated with the passenger.

In a possible implementation, the second virtual character may be a virtual character that meets the projection condition among the virtual characters participating in the virtual game. The projection condition may be, but is not limited to, an overall projection condition corresponding to the virtual game, a local projection condition corresponding to some game tasks in the virtual game, or a single projection condition corresponding to the current game task in which the first virtual character participates.

In a possible implementation, some game tasks in the virtual game may be, but are not limited to, game tasks in the virtual game that are associated with the current game task in which the first virtual character participates, such as game tasks that have been run before the current game task in which the first virtual character participates.

In a possible implementation, the display of the virtual projection may alternatively be understood as, but is not limited to, a manner of displaying information. For example, a controller user of the first virtual character may know the information efficiently by viewing the virtual projection. Compared with the obtaining of information in the related technology, this manner allows efficient obtaining of information through the virtual mobile device, thereby improving information display efficiency and improving the motivation to use the virtual vehicle.

By way of further example, based on the scene shown in FIG. 5, that the virtual mobile device 504 is a virtual vehicle is used as an example, and further, as shown in FIG. 8, 504 in FIG. 8 represents the virtual vehicle in this case. In a running process that the first virtual character 502 participates in the current game task, a current location of the first virtual character 502 in the scene of the virtual game is obtained. The first virtual character 502 is a virtual character controlled by the client. The current game task is a task in the virtual game. As shown by (a) in FIG. 8, the current location of the first virtual character 502 in the scene of the virtual game is not in the virtual vehicle 504 provided by the current game task. However, as shown by (b) in FIG. 8, the current location of the first virtual character 502 in the scene of the virtual game is in the virtual vehicle 504 provided by the current game task. Further, in the case that the current location is in the virtual vehicle 504 provided by the current game task, a virtual projection 802 corresponding to a second virtual character is displayed. The second virtual character is a virtual character that meets the projection condition among virtual characters participating in the virtual game.

According to this embodiment provided in this application, in a running process that a first virtual character participates in a current game task, a current location of the first virtual character in a scene of a virtual game is obtained, the first virtual character being a virtual character controlled by a client, and the current game task being a task in the virtual game; and a virtual projection corresponding to a second virtual character is displayed if it is determined that the current location is in a virtual mobile device provided by the current game task, the second virtual character being a virtual character that meets a projection condition among virtual characters participating in the virtual game. The current location of the virtual character current in the scene of the virtual game is identified to determine whether the virtual character matches the virtual mobile device, and the display of the virtual projection is further triggered by using the virtual mobile device further to provides a user with a manner of proactively triggering the display of a virtual projection. In this way, the virtual projection is flexibly displayed, thereby achieving a technical effect of improving information display efficiency.

In an exemplary embodiment, if the second virtual character is a first target virtual character, the displaying a virtual projection corresponding to a second virtual character if it is determined that the current location matches a virtual mobile device provided by the current game task includes:

displaying a first current screen on the client and displaying a virtual projection corresponding to the first target virtual character in the first current screen if it is determined that the current location is in the virtual mobile device and the virtual mobile device is a mobile vehicle provided by the current game task at an initial stage, the first target virtual character being set to enter a virtual scene of the current game task through the mobile vehicle, and the first target virtual character being a virtual character that meets the projection condition among virtual characters participating in a target game task, the target game task being at least one task in the virtual game other than the current game task.

In a possible implementation, in this embodiment, the current game task may be divided into, but is not limited to, an initial stage, a battle stage, a settlement stage, and the like. The initial stage may be understood as, but is not limited to, a previous stage of the battle stage, and at the initial stage, a virtual character participating in a game is set to enter the battle stage through the mobile vehicle.

In a possible implementation, the first current screen displayed on the client may be understood as, but is not limited to, a screen currently displayed on the client, such as a movement screen associated with the mobile vehicle, a screen of a region in which the mobile vehicle is located, a screen displayed by the client in response to a viewing angle adjustment instruction, or a presentation screen automatically selected for the client.

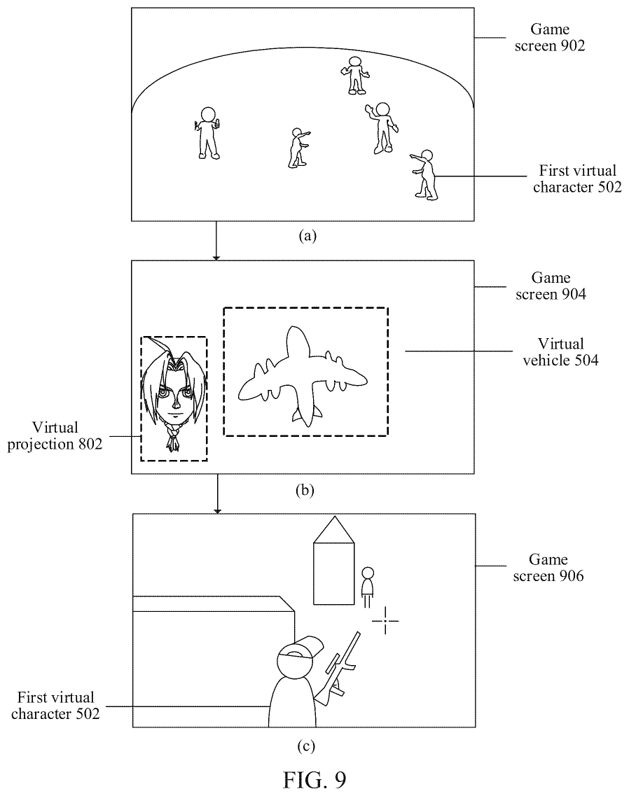

By way of further example, based on the scene shown in FIG. 8, further, as shown in FIG. 9, in the running process that the first virtual character 502 participates in the current game task, the current location of the first virtual character 502 in the scene of the virtual game is obtained. The first virtual character 502 is a virtual character controlled by the client. The current game task is a task in the virtual game. As shown by (a) in FIG. 9, the current location of the first virtual character 502 in the scene of the virtual game is not in the virtual vehicle 504 provided by the current game task. However, as shown by (b) in FIG. 9, the current location of the first virtual character 502 in the scene of the virtual game is in the virtual vehicle 504 provided by the current game task. Further, in the case that the current location is in the virtual vehicle 504 provided by the current game task, a virtual projection 802 corresponding to a second virtual character is displayed. The second virtual character is a virtual character that meets the projection condition among virtual characters participating in the virtual game.

Furthermore, in this embodiment, as shown by (a) in FIG. 9 and (b) in FIG. 9, the first virtual character 502 is currently at the initial stage of the current game task. For example, a game screen 902 displays the first virtual character 502, and a game screen 904 displays the virtual vehicle 504 and the virtual projection 802. As shown by (c) in FIG. 9, the first virtual character 502 is currently at the battle stage of the current game task. For example, a game screen 906 displays the first virtual character 502.

In a possible implementation, in this embodiment, as shown by (b) in FIG. 9, the movement screen (the game screen 904) of the virtual vehicle 504 (the mobile vehicle) is displayed on the client, and the virtual projection 802 corresponding to the first target virtual character (the first virtual character 502) is displayed in the movement screen. Further, as shown by (c) in FIG. 9, the first target virtual character (the first virtual character 502) is caused to enter the virtual scene (the game screen 906) of the current game task through the virtual vehicle 504 (the mobile vehicle).

According to this embodiment provided in this application, if it is determined that the current location is in the virtual mobile device and the virtual mobile device is a mobile vehicle provided by the current game task at the initial stage, the movement screen of the virtual mobile device is displayed on the client, and the virtual projection corresponding to the first target virtual character is displayed in the movement screen. In this way, the virtual projection is flexibly displayed, thereby achieving a technical effect of improving information display efficiency.

In an exemplary embodiment, before the displaying a first current screen on the client, and displaying a virtual projection corresponding to the first target virtual character in the first current screen, the method further includes:
S1: obtaining virtual projection resources held by the virtual characters participating in the target game task; and
S2: determining a virtual character corresponding to virtual projection resources whose resource amount is greater than or equal to a projection threshold as the first target virtual character meeting the projection condition.

In a possible implementation, the virtual projection resource may be, but is not limited to, a resource that is fed back by the virtual character after consumption of a virtual resource and that is associated with the virtual projection. The virtual resource may be understood as, but not limited to, a resource that is allowed to be consumed in the virtual game to exchange for various types of use permission. The use permission may include, but is not limited to, at least one of the following: use permission for various types of virtual items, use permission for various types of virtual scenes, use permission for various types of virtual characters, or the like.

In a possible implementation, the virtual projection resource may be, but is not limited to, a specified resource associated with the virtual projection, such as a virtual projection item. By way of further example, in a possible implementation, for example, the display of the virtual projection is triggered proactively in response to a projection display instruction triggered for the virtual projection item, or a holding status for the virtual projection item is automatically detected and the projection display instruction is automatically triggered to trigger the display of the virtual projection.

In an exemplary embodiment, the displaying a movement screen of the virtual mobile device on the client and displaying a virtual projection corresponding to the first target virtual character in the movement screen if it is determined that the current location is in the virtual mobile device and the virtual mobile device is a mobile vehicle provided by the current game task at an initial stage includes:
S1: obtaining first battle information of the virtual characters participating in the target game task if it is determined that the current location is in the virtual mobile device and the virtual mobile device is a mobile vehicle provided by the current game task at the initial stage;
S2: determining, according to the first battle information, the first target virtual character meeting the projection condition from the virtual characters participating in the target game task; and
S3: displaying the movement screen of the virtual mobile device on the client, and displaying the virtual projection corresponding to the first target virtual character in the movement screen.

In a possible implementation, the first battle information may be, but is not limited to, battle information of each of the virtual characters in at least one task, such as a quantity of winning battles, a quantity of losing battles, a quantity of defeats in a battle, a quantity of assists in a battle, a quantity of specific events completed in a battle, a battle winning rate, or kill/death/assist (KDA) of a battle.

In a possible implementation, a time interval between a task end point corresponding to each task in the target game task and a task starting point corresponding to the current game task is less than or equal to a time threshold, or may be understood as N tasks before the current game task, N being a natural number.

In a possible implementation, a time interval between a task end point corresponding to each task in the target game task and a task starting point corresponding to the current game task is less than or equal to a time threshold.

By way of further example, for example, as shown by (b) in FIG. 8, a dynamic projection of a winning character of the currently running game task as the virtual projection 802 to increase, in a manner of displaying the virtual projection of the winning character, the motivation of a user to complete the game task.

In an exemplary embodiment, the determining, according to the first battle information, the first target virtual character meeting the projection condition from the virtual characters participating in the target game task includes at least one of the following:
S1: determining, according to the first battle information, a virtual character completing a largest quantity of first subtasks in the virtual characters participating in the target game task as the first target virtual character, the first battle information including a quantity of first subtasks completed by each of the virtual characters participating in the target game task, and the first subtask being a task in the virtual game;
S2: determining, according to the first battle information, a virtual character completing a second subtask among all tasks in the virtual characters participating in the target game task as the first target virtual character, the first battle information being configured for indicating whether the virtual characters participating in the target game task each complete the second subtask; or
S3: determining, according to the first battle information, a virtual character having an association relationship with the first virtual character in the virtual characters participating in the target game task as the first target virtual character, the first battle information being configured for indicating whether the virtual characters participating in the target game task each have an association relationship with the first virtual character.

In a possible implementation, the first subtask in the virtual game may be understood as, but not limited to, a specific task under the general concept of the virtual game. For example, the first subtask may be a historical defeat event associated with all game accounts of the virtual game, and a quantity of completed first subtasks may be, but is not limited to, a quantity of defeats.

In a possible implementation, the second subtask among all tasks of the target game task may be understood as, but not limited to, a specific task of the game task. For example, the second subtask may be a historical battle event participated by each virtual character that participates in at least one task. To improve the fun of the game, the historical battle events may be set to, but are not limited to, some special events that are more interesting, such as events with a quantity of defeats of 0 but the game won. To improve the motivation for the game, the historical battle events may alternatively be set to, but are not limited to, some special events that are more difficult to operate, such as exceeding a virtual character that completes a target defeat quantity event in a single game.

In a possible implementation, a virtual character having an association relationship with the first virtual character, such as a virtual character whose degree of interaction with the first virtual character reaches an interaction threshold, has an association relationship with the first virtual character. In addition, when being online, the virtual character having an association relationship with the first virtual character may alternatively be used as, but not limited to, a display object for the virtual projection.

In an exemplary embodiment, if the second virtual character is a second target virtual character, the displaying a virtual projection corresponding to a second virtual character if it is determined that the current location matches a virtual mobile device provided by the current game task includes:

displaying a second current screen on the client and displaying a virtual projection corresponding to the second target virtual character in the second current screen if it is determined that the current location is in the virtual mobile device and the virtual mobile device is a control vehicle provided by the current game task for the first virtual character at a battle stage, the second target virtual character being a virtual character meeting the projection condition among virtual characters participating in the current game task.

In a possible implementation, the current game task may be divided into, but not limited to, an initial stage, a battle stage, a settlement stage, and the like. The initial stage may be understood as, but not limited to, a previous stage of the battle stage, and at the initial stage, a virtual character participating in a game is set to enter the battle stage through the mobile vehicle.

In a possible implementation, the second current screen displayed on the client may be understood as, but not limited to, a screen currently displayed on the client, such as a control screen associated with the mobile vehicle, a screen of a region in which the mobile vehicle is located, a screen displayed by the client in response to a viewing angle adjustment instruction, or a presentation screen automatically selected for the client.

By way of further example, based on the scene shown in FIG. 8, further, as shown in FIG. 9, that the virtual mobile device is a virtual vehicle is used as an example. In the running process that the first virtual character 502 participates in the current game task, the current location of the first virtual character 502 in the scene of the virtual game is obtained. The first virtual character 502 is a virtual character controlled by the client. The current game task is a task in the virtual game. As shown by (a) in FIG. 9, the current location of the first virtual character 502 in the scene of the virtual game is not in the virtual vehicle 504 provided by the current game task. However, as shown by (b) in FIG. 9, the current location of the first virtual character 502 in the scene of the virtual game is in the virtual vehicle 504 provided by the current game task. Further, in the case that the current location is in the virtual vehicle 504 provided by the current game task, a virtual projection 802 corresponding to a second virtual character is displayed. The second virtual character is a virtual character that meets the projection condition among virtual characters participating in the virtual game.

Furthermore, in this embodiment, as shown by (a) in FIG. 9 and (b) in FIG. 9, the first virtual character 502 is currently at the initial stage of the current game task. For example, a game screen 902 displays the first virtual character 502, and a game screen 904 displays the virtual vehicle 504 and the virtual projection 802. As shown by (c) in FIG. 9, the first virtual character 502 is currently at the battle stage of the current game task. For example, a game screen 906 displays the first virtual character 502.

In a possible implementation, as shown by (b) in FIG. 9, the movement screen (the game screen 904) of the virtual vehicle 504 (the mobile vehicle) is displayed on the client, and the virtual projection 802 corresponding to the first target virtual character (the first virtual character 502) is displayed in the movement screen. Further, as shown by (c) in FIG. 9, the first target virtual character (the first virtual character 502) is caused to enter the virtual scene (the game screen 906) of the current game task through the virtual vehicle 504 (the mobile vehicle).

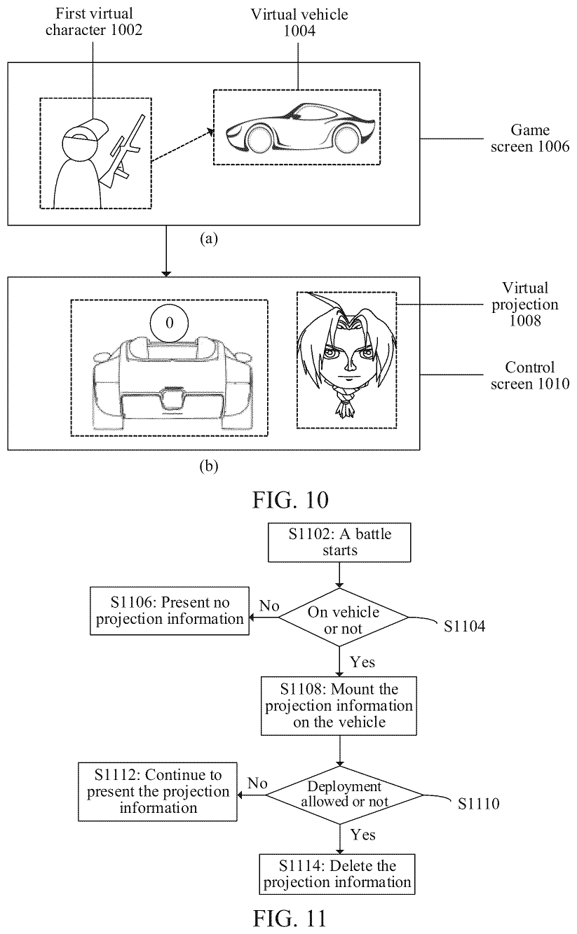

By way of further example, in a possible implementation, for example, as shown in FIG. 10, a game screen 1006 is displayed, and a first virtual character 1002 at a battle stage and a virtual vehicle 1004 located around the first virtual character 1002 are displayed in the game screen 1006, as shown by (a) in FIG. 10. Further, as shown by (b) in FIG. 10, when the current location is in the virtual vehicle 1004 (the control vehicle), a control screen 1010 (a second current screen) of the virtual vehicle 1004 is displayed on the client, and a virtual projection 1008 corresponding to a second target virtual character is displayed in the control screen 1010. The second target virtual character is a virtual character that meets a projection condition in the current game task.

According to this embodiment provided in this application, the second current screen of the virtual mobile device is displayed on the client and the virtual projection corresponding to the second target virtual character is displayed in the second current screen if it is determined that the current location is in the virtual mobile device and the virtual mobile device is a control vehicle provided by the current game task for the first virtual character at the battle stage. In this way, the virtual projection is flexibly displayed, thereby achieving a technical effect of improving information display efficiency.

In an exemplary embodiment, before the displaying a second current screen on the client and displaying a virtual projection corresponding to the second target virtual character in the second current screen, the method further includes:
S1: obtaining virtual projection resources held by the virtual characters participating in the current game task; and
S2: determining a virtual character corresponding to virtual projection resources whose resource amount is greater than or equal to a projection threshold as the second target virtual character meeting the projection condition.

In a possible implementation, the virtual projection resource may be, but is not limited to, a resource that is fed back by the virtual character after consumption of a virtual resource and that is associated with the virtual projection. The virtual resource may be understood as, but not limited to, a resource that is allowed to be consumed in the virtual game to exchange for various types of use permission. The use permission may include, but is not limited to, at least one of the following: use permission for various types of virtual items, use permission for various types of virtual scenes, use permission for various types of virtual characters, or the like.

In a possible implementation, the virtual projection resource may be, but is not limited to, a specified resource associated with the virtual projection, such as a virtual projection item. By way of further example, in a possible implementation for example, the display of the virtual projection is triggered proactively in response to a projection display instruction triggered for the virtual projection item, or a holding status for the virtual projection item is automatically detected and the projection display instruction is automatically triggered to trigger the display of the virtual projection.

In an exemplary embodiment, the displaying a second current screen on the client and displaying a virtual projection corresponding to the second target virtual character in the second current screen if it is determined that the current location is in the virtual mobile device and the virtual mobile device is a control vehicle provided by the current game task for the first virtual character at a battle stage includes:
S1: obtaining second battle information of the virtual characters participating in the current game task if it is determined that the current location is in the virtual mobile device and the virtual mobile device is the control vehicle;
S2: determining, according to the second battle information, the second target virtual character meeting the projection condition from the virtual characters participating in the current game task; and
S3: displaying the second current screen on the client, and displaying the virtual projection corresponding to the second target virtual character in the second current screen.

In a possible implementation, in this embodiment, the second battle information may be, but is not limited to, historical battle information and real-time battle information of the virtual characters in the current game task, such as performance data of the virtual characters in the current game task in historical battle tasks, to help the user further understand opponent information or the like in the current game task; or real-time data of the virtual characters in the current game task in the current battle task, to help the user understand the progress of the current game task in a timely manner.

By way of further example, in a possible implementation, for example, if it is determined that the current location is in the virtual mobile device and the virtual mobile device is the control vehicle, a quantity of real-time defeats in the current game task of each of the virtual characters participating in the current game task is obtained, and a virtual character with a largest quantity of defeats is displayed on the client in a manner of a virtual projection.

According to this embodiment provided in this application, the second battle information of the virtual characters participating in the current game task is obtained if it is determined that the current location is in the virtual mobile device and the virtual mobile device is the control vehicle. The second target virtual character meeting the projection condition is determined, according to the second battle information, from the virtual characters participating in the current game task. The second current screen is displayed on the client, and the virtual projection corresponding to the second target virtual character is displayed in the second current screen. In this way, the virtual projection is flexibly displayed, thereby achieving a technical effect of improving information display efficiency.

In an exemplary embodiment, the determining, according to the second battle information, the second target virtual character meeting the projection condition from the virtual characters participating in the current game task includes at least one of the following:
S1: determining, according to the second battle information, a virtual character with a longest completion progress with respect to the current game task in the virtual characters participating in the current game task as the second target virtual character, the second battle information including a completion progress of each of the virtual characters participating in the current game task with respect to the current game task;
S2: determining, according to the second battle information, a virtual character completing a largest quantity of third subtasks in the virtual characters participating in the current game task as the second target virtual character, the second battle information including a quantity of third subtasks completed by each of the virtual characters participating in the current game task, and the third subtask being a task in the current game task;
S3: determining, according to the second battle information, a virtual character completing a fourth subtask in the current game task in the virtual characters participating in the current game task as the second target virtual character, the second battle information being configured for indicating whether the virtual characters participating in the current game task each complete the fourth subtask;
S4: determining, according to the second battle information, a virtual character located within a field of view corresponding to the first virtual character in the virtual characters participating in the current game task as the second target virtual character, the second battle information including a current location of each of the virtual characters participating in the current game task;
S5: determining, according to the second battle information, a virtual character that has used the virtual mobile device in the virtual characters participating in the current game task as the second target virtual character, the second battle information being configured for indicating whether the virtual characters participating in the current game task each have used the virtual mobile device; or
S6: determining, in the virtual characters participating in the current game task according to the second battle information, a virtual character belonging to a same camp as the first virtual character as the second target virtual character, the second battle information including a camp of each of the virtual characters participating in the current game task.

In a possible implementation, when the completion of the current game task is allowed to be visually presented in a progress form, the completion progress of the current game task may alternatively be displayed in, but not limited to, the form of the virtual projection. For example, if it is assumed that the completion progress of the current game task is 100%, the virtual character with the highest progress may be presented in, but not limited to, the form of a virtual projection.

In a possible implementation, the third subtask in the current game task may be understood as, but not limited to, a specific task of the game task. For example, the third subtask is a historical defeat event associated with all game accounts of the game task, and a quantity of third subtasks may be, but is not limited to, a quantity of defeats.

In a possible implementation, the fourth subtask in the current game task may be understood as, but not limited to, a specific task of the game task. For example, the fourth subtask is a specific task event participated by each virtual character that participates in a task. To improve the fun of the game, the specific task events may be set to, but are not limited to, some special events that are more interesting, such as events with a quantity of defeats of 0 but the game won. To improve the motivation for the game, the specific task events may alternatively be set to, but are not limited to, some special events that are more difficult to operate, such as exceeding a virtual character that completes a target defeat quantity event in a single game. To improve the presentation comprehensiveness of game information, the specific task events may alternatively be set to, but are not limited to, strategic events, such as occupying a target region, obtaining a target item, and other specific task events.

In a possible implementation, to improve the timeliness of obtaining information, the virtual projection may be set to, but is not limited to, a projection corresponding to a virtual character located within a field of view corresponding to the first virtual character. In this way, the first virtual character may obtain, by controlling the virtual mobile device, field of view information corresponding to the virtual character located within the field of view corresponding to the first virtual character.

In a possible implementation, to improve the comprehensiveness of obtaining information, the virtual projection may be set to, but is not limited to, a projection corresponding to a virtual character that has used the virtual mobile device. In this way, the first virtual character may obtain, by controlling the virtual mobile device, related information corresponding to the virtual character that has used the virtual mobile device.

In an exemplary embodiment, the virtual mobile device is a virtual vehicle, and the displaying a virtual projection corresponding to a second virtual character if it is determined that the current location matches a virtual mobile device provided by the current game task includes:
S1: obtaining a first model corresponding to the second virtual character if it is determined that the current location is in the virtual vehicle;
S2: mounting the first model on a mesh of a second model corresponding to the virtual vehicle to obtain a mounted second model; and
S3: rendering the mounted second model to display the virtual projection corresponding to the second virtual character.

Conventional projection technologies such as RenderTexture (RT) can present a projected character in front of the user in a form of a plane, and cannot dynamically mount the projected character onto a moving vehicle. In a possible implementation, in this embodiment, in a manner of creating a character model (Actor) of the projected character and mounting the projected character onto a model mesh of the mobile vehicle, the virtual projection can move with the vehicle.

By way of further example, in a possible implementation, for example, first, a character model of the projected character is created, and medals, borders, colliders, and characters included by the projected character are mounted on the character model as components. Further, after the character model is initialized, the projected character is attached to the model mesh of the vehicle, thereby enabling the virtual projection to move with the vehicle.

According to this embodiment provided in this application, a first model corresponding to the second virtual character is obtained if it is determined that the current location is in the virtual vehicle. The first model is mounted on a mesh of a second model corresponding to the virtual vehicle to obtain a mounted second model. The mounted second model is rendered to display the virtual projection corresponding to the second virtual character. In this way, the possibility of projection information that moves with character location changes is achieved by binding to the virtual vehicle, thereby achieving a technical effect of improving the display flexibility of the virtual projection.

In an exemplary embodiment, the obtaining a first model corresponding to the second virtual character includes:
S1: creating an initial model of the second virtual character; and
S2: when at least one projection component associated with the second virtual character is obtained, mounting the at least one projection component on the initial model to obtain the first model.

By way of further example, in one embodiment, for example, as shown by the content in FIG. 11, the possibility of projection information that moves with user character location changes is achieved by binding to the mobile vehicle. Specific blocks are as follows:

S1102: A battle starts, and a user receives no information.

S1104: After the user boards a vehicle, a backend determines whether the user is on the vehicle, and if yes, performs S1108, or if no, performs S1106.

S1106: Present no projection information.

S1108: Mount the projection information on the vehicle with the front facing the user to allow the user to maintain the information visible at all times.

S1110: Determine again whether the user is on the vehicle, and if yes, perform S1112, or if no, perform S1114.

S1112: Continue to present the projection information.

S1114: Delete the projection information to reduce memory pressure, at which time, the user can no longer receive the information.

According to this embodiment provided in this application, an initial model of the second virtual character is created; and when at least one projection component associated with the second virtual character is obtained, the at least one projection component is mounted on the initial model to obtain the first model. In this way, the possibility of projection information that moves with character location changes is achieved by binding to the virtual vehicle, thereby achieving a technical effect of improving the display flexibility of the virtual projection.

In an exemplary embodiment, the virtual mobile device is a virtual vehicle, and during the displaying a virtual projection corresponding to a second virtual character, the method further includes: creating an association relationship between the first virtual character and the virtual vehicle if it is determined that the current location is in the virtual mobile device.

In an exemplary embodiment, after the displaying a virtual projection corresponding to a second virtual character, the method further includes: in response to a termination instruction triggered for the virtual vehicle, terminating the association relationship and canceling the display of the virtual projection corresponding to the second virtual character.

In a possible implementation, to ensure relatively low performance consumption, information about the virtual projection is visible only to the user currently located in the virtual vehicle provided by the current game task, and disappears as a status of the user changes. For example, when the association relationship between the first virtual character and the virtual vehicle is terminated, the display of the virtual projection corresponding to the second virtual character is canceled.

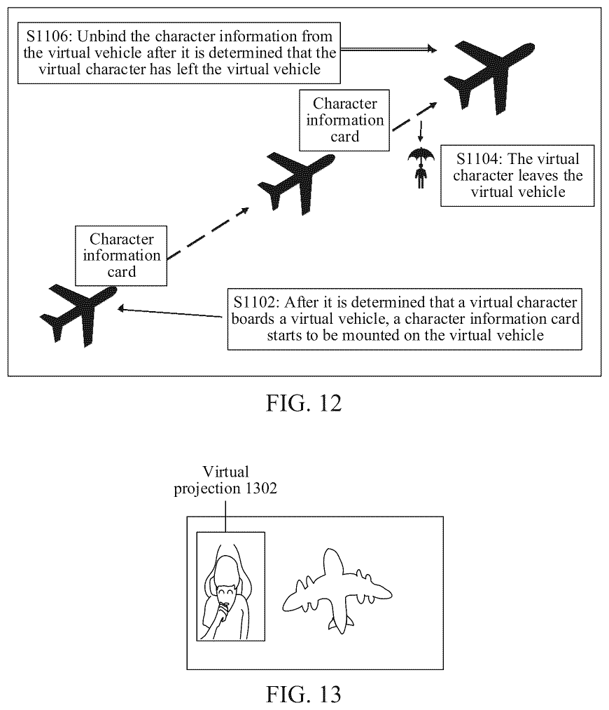

By way of further example, in one embodiment, for example, for determining projected content, it is assumed that a projected user may be, but is not limited to, a user who has performed optimally in previous games, or a user that performs well in the current game. The projected content may be, but is not limited to, a character information card including a dynamic model of the user. Specifically, as shown in FIG. 12, a backend determines a status of each user. After the user boards the vehicle, a dynamic projection (that is, the character information card) starts to be mounted on the vehicle, at which time, the user is in a riding state and cannot control the character of the user to move. However, the information always appears in a screen viewing angle of the user because it is mounted on the vehicle that moves together with the user. In this process, the backend maintains the determining of the status of the user. When the user leaves the vehicle (that is, is no longer bound to the vehicle), the dynamic projection (the character information card) also disappears immediately to reduce memory consumption. Specific blocks are as follows:

S1102: After it is determined that a virtual character boards a virtual vehicle, a character information card starts to be mounted on the virtual vehicle.

S1104: The virtual character leaves the virtual vehicle.

S1106: Unbind the character information from the virtual vehicle after it is determined that the virtual character has left the virtual vehicle.

In an exemplary embodiment, after the displaying a virtual projection corresponding to a second virtual character, the method includes at least one of the following:
S1: displaying character information corresponding to the second virtual character in response to a view instruction triggered for the virtual projection corresponding to the second virtual character;
S2: displaying an interactive interface corresponding to the second virtual character in response to an interaction instruction triggered for the virtual projection corresponding to the second virtual character, the interactive interface being configured to establish an information exchange channel between the first virtual character and the second virtual character; or
S3: playing a battle screen of the second virtual character in the virtual game in response to a watch instruction triggered for the virtual projection corresponding to the second virtual character.

In a possible implementation, to improve the comprehensiveness of information processing, a further viewing operation may be further performed on the virtual projection, such as displaying character information corresponding to the second virtual character in response to a view instruction triggered for the virtual projection corresponding to the second virtual character; displaying an interactive interface corresponding to the second virtual character in response to an interaction instruction triggered for the virtual projection corresponding to the second virtual character; and playing a battle screen of the second virtual character in the virtual game in response to a watch instruction triggered for the virtual projection corresponding to the second virtual character.

For ease of understanding, the foregoing information processing method is applied to a shooting game scene. A dynamically projected character is separated, and mounted on a component of a vehicle (such as a virtual aircraft) during flight. In this way, the projected character moves with character location changes of a user, enabling the user to maintain normal transmission of information when the user cannot control the virtual character to move (for example, when the user is in a vehicle riding state or a controlled state).

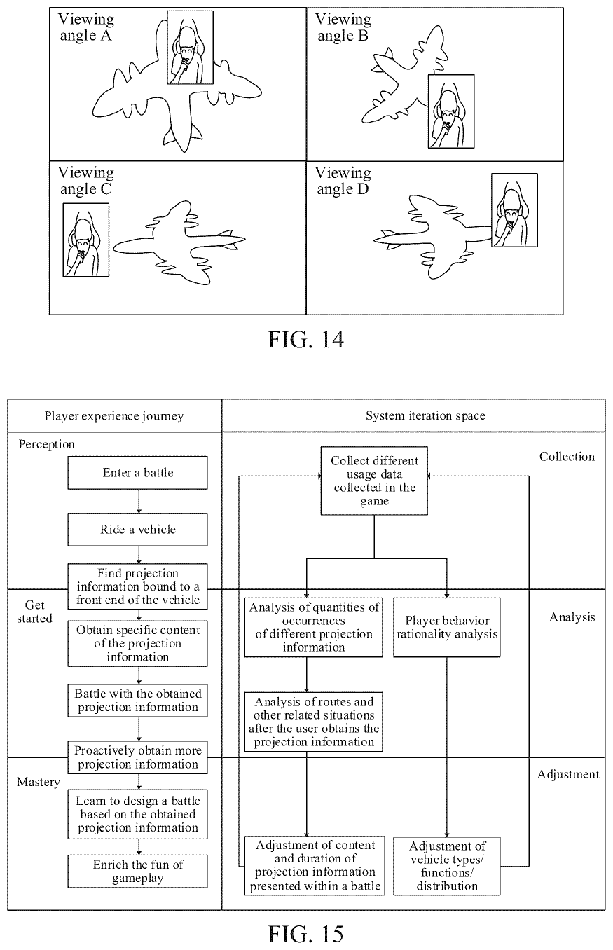

By way of further example, the user initially boards the vehicle, at which time, the user does not move the viewing angle, the dynamic projection is bound to the aircraft vehicle, and the front of the information card is presented to the user. In a possible implementation, for example, as shown in FIG. 13, the front of the information card is presented to the user in a form of a virtual projection 1302. Furthermore, the user is fixed to the vehicle at this time and maintains a state of always moving together with the vehicle. Therefore, the information card moves with the character location changes of the user. However, because the movement of the user character is restricted at this time, regardless of how the user moves the screen viewing angle, the dynamic projection of the user always appears in the screen, maintaining correct transmission of the information. In a possible implementation, for example, as shown in FIG. 14, in a game screen under screen viewing angles corresponding to a viewing angle A, a viewing angle B, a viewing angle C, and a viewing angle D, the dynamic projection of the user always appears in the screen, maintaining correct transmission of the information.

In addition, in a possible implementation, for example, because the information card further includes resources such as dynamic character actions, in order to ensure relatively low performance consumption, the information is visible only to the current operating user, and disappears as a status of the user changes.

In a possible implementation, this embodiment provides different benefits to the user in terms of player experience journey and system iteration space. As shown in FIG. 15, this embodiment provides incremental experience and benefits and overall iteration space to the user on the product side of the player experience journey. Using the projection information solution in this embodiment that movement is achieved by binding to the mobile vehicle, the user can quickly perceive its existence (perception), understand its mechanism of action, and start from trying to use information to fight to designing tactics based on the information (get started). This enriches the gaming experience and fun of the gameplay of the user (mastery). Compared with mainstream solutions, the solution of binding to a mobile vehicle in this embodiment achieves a dynamic character projection that moves as the location of the user character changes, allowing the user to maintain normal transmission of information during passive movement and ensuring that the user has sufficient information acquisition space.

In a possible implementation, for designers on a research and development side of the system iteration space, quantities of occurrences of different projection information in the game and performance data of the user after obtaining the information are collected (collection) and analyzed thoroughly (analysis). This ensures that the system designers have sufficient room to adjust the presented content and duration within a battle, and ensures the determining of a future direction (adjustment), allowing the designers to more easily make projected character settings that are consistent with the worldview settings.

In addition, the user needs to learn to quickly deploy own tactics through the obtained data information related to the character projection. This process is gradual and progressive. In the end, the user can design tactics by combining items, character skills, and the like during the game to enrich own gameplay routines, achieving more diverse battle experience. Additionally, on the research and development side, vehicle types/functions/distribution can be adjusted based on this to provide the user with a more in-depth battle experience.

According to this embodiment provided in this application, compared with the conventional solution in which the projection information of the user character is presented at a fixed location, this application provides a solution of achieving a dynamic projected character that moves as the location of the user character changes by binding to a mobile vehicle. This achieves the dynamic projected character that moves as the user character changes, allowing the user to maintain normal transmission of information during passive movement. On the premise that the basic settings such as gameplay, maps, and attack items remain unchanged, this application can bring a more novel experience to users without affecting the basic game experience, increasing the fun of the user playing in the battle. For designers on the research and development side, the foregoing mechanism provides more room for diversified content delivery and better scalability of related systems.

The specific implementations of this application involve user information and other relevant data. When the foregoing embodiments of this application are applied to specific products or technologies, separate permission or consent from the user is required, and the collection, use, and processing of the relevant data need to comply with the relevant laws, and regulations, and standards of relevant countries and regions

For ease of description, the foregoing method embodiments are stated as a combination of a series of actions. However, a person skilled in the art is to know that this application is not limited by the described action sequence, because according to this application, some steps may be performed in another sequence or simultaneously. In addition, a person skilled in the art is further to understand that the embodiments described in this specification are all exemplary embodiments, and the involved actions and modules are not necessarily required by this application.

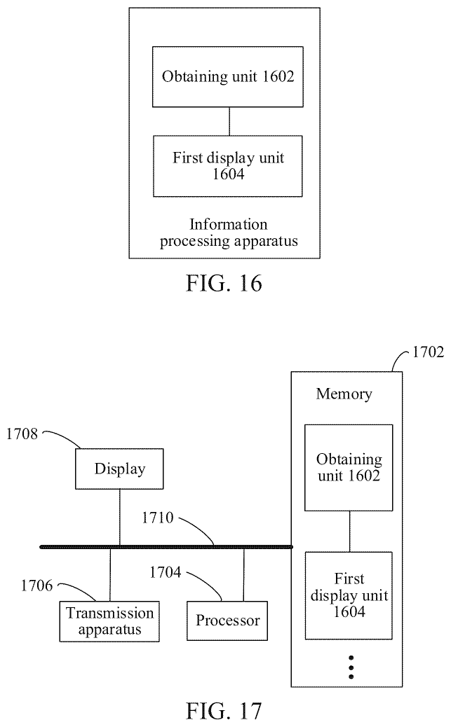

According to another aspect of the embodiments of this application, an information processing apparatus configured to implement the foregoing information processing method is further provided. As shown in FIG. 16, the apparatus includes:
an obtaining unit 1602, configured to: in a running process that a first virtual character participates in a current game task, obtain a current location of the first virtual character in a scene of a virtual game, the first virtual character being a virtual character controlled by a client, and the current game task being a task in the virtual game; and
a first display unit 1604, configured to display a virtual projection corresponding to a second virtual character if it is determined that the current location matches a virtual mobile device provided by the current game task, the second virtual character being a virtual character that meets a projection condition among virtual characters participating in the virtual game.

For a specific embodiment, refer to the example described in the foregoing information processing method. Details are not described herein again in this example.

According to this embodiment provided in this application, in a running process that a first virtual character participates in a current game task, a current location of the first virtual character in a scene of a virtual game is obtained, the first virtual character being a virtual character controlled by a client, and the current game task being a task in the virtual game; and a virtual projection corresponding to a second virtual character is displayed if it is determined that the current location is in a virtual mobile device provided by the current game task, the second virtual character being a virtual character that meets a projection condition among virtual characters participating in the virtual game. The current location of the virtual character current in the scene of the virtual game is identified to determine whether the virtual character matches the virtual mobile device, and the display of the virtual projection is further triggered by using the virtual mobile device further to provides a user with a manner of proactively triggering the display of a virtual projection. In this way, the virtual projection can be flexibly displayed, so that the technical effect of improving information display efficiency is achieved.

In an exemplary embodiment, the virtual mobile device is a virtual vehicle, and the first display unit 1604 is configured to determine that the current location matches the virtual mobile device if it is determined that the current location is in the virtual vehicle.

In an exemplary embodiment, the first display unit 1604 includes:
a first display module, configured to display a first current screen on the client and display a virtual projection corresponding to a first target virtual character in the first current screen if it is determined that the current location is in the virtual mobile device and the virtual mobile device is a mobile vehicle provided by the current game task at an initial stage, the first target virtual character being set to enter a virtual scene of the current game task through the mobile vehicle, and the first target virtual character being a virtual character that meets the projection condition among virtual characters participating in a target game task, the target game task being at least one task in the virtual game other than the current game task.

For a specific embodiment, refer to the example described in the foregoing information processing method. Details are not described herein again in this example.

In an exemplary embodiment, the apparatus is further configured to:
before displaying the first current screen on the client, and displaying the virtual projection corresponding to the first target virtual character in the first current screen, obtain virtual projection resources held by the virtual characters participating in the target game task; and
determine a virtual character corresponding to virtual projection resources whose resource amount is greater than or equal to a projection threshold as the first target virtual character meeting the projection condition.

In an exemplary embodiment, the first display module includes:
a first obtaining submodule, configured to obtain first battle information of the virtual characters participating in the target game task if it is determined that the current location is in the virtual mobile device and the virtual mobile device is a mobile vehicle provided by the current game task at the initial stage;
a first determining submodule, configured to determine, according to the first battle information, the first target virtual character meeting the projection condition from the virtual characters participating in the target game task; and
a first display submodule, configured to display the first current screen on the client, and display the virtual projection corresponding to the first target virtual character in the first current screen.

For a specific embodiment, refer to the example described in the foregoing information processing method. Details are not described herein again in this example.

In an exemplary embodiment, the first determining submodule includes at least one of the following:
a first determining subunit, configured to determine, according to the first battle information, a virtual character completing a largest quantity of first subtasks in the virtual characters participating in the target game task as the first target virtual character, the first battle information including a quantity of first subtasks completed by each of the virtual characters participating in the target game task, and the first subtask being a task in the virtual game;
a second determining subunit, configured to determine, according to the first battle information, a virtual character completing a second subtask among all tasks in the virtual characters participating in the target game task as the first target virtual character, the first battle information being configured for indicating whether the virtual characters participating in the target game task each complete the second subtask; or
a third determining subunit, configured to determine, according to the first battle information, a virtual character having an association relationship with the first virtual character in the virtual characters participating in the target game task as the first target virtual character, the first battle information being configured for indicating whether the virtual characters participating in the target game task each have an association relationship with the first virtual character.

For a specific embodiment, refer to the example described in the foregoing information processing method. Details are not described herein again in this example.

In an exemplary embodiment, the first display unit 1604 includes:
a second display module, configured to display a second current screen on the client and display a virtual projection corresponding to a second target virtual character in the second current screen if it is determined that the current location is in the virtual mobile device and the virtual mobile device is a control vehicle provided by the current game task for the first virtual character at a battle stage, the second target virtual character being a virtual character meeting the projection condition among virtual characters participating in the current game task.

For a specific embodiment, refer to the example described in the foregoing information processing method. Details are not described herein again in this example.

In an exemplary embodiment, the apparatus is further configured to:
before displaying the second current screen on the client, and displaying the virtual projection corresponding to the second target virtual character in the second current screen, obtain virtual projection resources held by the virtual characters participating in the current game task; and
determine a virtual character corresponding to virtual projection resources whose resource amount is greater than or equal to a projection threshold as the second target virtual character meeting the projection condition.

In an exemplary embodiment, the second display module includes:
a second obtaining submodule, configured to obtain second battle information of the virtual characters participating in the current game task if it is determined that the current location is in the virtual mobile device and the virtual mobile device is the control vehicle;
a second determining submodule, configured to determine, according to the second battle information, the second target virtual character meeting the projection condition from the virtual characters participating in the current game task; and
a second display submodule, configured to display the second current screen on the client, and display the virtual projection corresponding to the second target virtual character in the second current screen.

For a specific embodiment, refer to the example described in the foregoing information processing method. Details are not described herein again in this example.

In an exemplary embodiment, the second determining submodule includes at least one of the following:
a fourth determining subunit, configured to determine, according to the second battle information, a virtual character with a longest completion progress with respect to the current game task in the virtual characters participating in the current game task as the second target virtual character, the second battle information including a completion progress of each of the virtual characters participating in the current game task with respect to the current game task;
a fifth determining subunit, configured to determine, according to the second battle information, a virtual character completing a largest quantity of third subtasks in the virtual characters participating in the current game task as the second target virtual character, the second battle information including a quantity of third subtasks completed by each of the virtual characters participating in the current game task, and the third subtask being a task in the current game task;
a sixth determining subunit, configured to determine, according to the second battle information, a virtual character completing a fourth subtask in the current game task in the virtual characters participating in the current game task as the second target virtual character, the second battle information being configured for indicating whether the virtual characters participating in the current game task each complete the fourth subtask;
a seventh determining subunit, configured to determine, according to the second battle information, a virtual character located within a field of view corresponding to the first virtual character in the virtual characters participating in the current game task as the second target virtual character, the second battle information including a current location of each of the virtual characters participating in the current game task;
an eighth determining subunit, configured to determine, according to the second battle information, a virtual character that has used the virtual mobile device in the virtual characters participating in the current game task as the second target virtual character, the second battle information being configured for indicating whether the virtual characters participating in the current game task each have used the virtual mobile device; or
a ninth determining subunit, configured to determine, in the virtual characters participating in the current game task according to the second battle information, a virtual character belonging to a same camp as the first virtual character as the second target virtual character, the second battle information including a camp of each of the virtual characters participating in the current game task.

For a specific embodiment, refer to the example described in the foregoing information processing method. Details are not described herein again in this example.

In an exemplary embodiment, the virtual mobile device is a virtual vehicle, and the first display unit 1604 includes:
an obtaining module, configured to obtain a first model corresponding to the second virtual character if it is determined that the current location is in the virtual vehicle;
a mount module, configured to mount the first model on a mesh of a second model corresponding to the virtual vehicle to obtain a mounted second model; and
a rendering module, configured to render the mounted second model to display the virtual projection corresponding to the second virtual character.

For a specific embodiment, refer to the example described in the foregoing information processing method. Details are not described herein again in this example. In an exemplary embodiment, the obtaining module includes:
a creation submodule, configured to create an initial model of the second virtual character; and
a mount submodule, configured to: when at least one projection component associated with the second virtual character is obtained, mount the at least one projection component on the initial model to obtain the first model.

For a specific embodiment, refer to the example described in the foregoing information processing method. Details are not described herein again in this example.

In an exemplary embodiment, the virtual mobile device is a virtual vehicle, and the apparatus includes: a creation unit, configured to: during the display of the virtual projection corresponding to the second virtual character, create an association relationship between the first virtual character and the virtual vehicle if it is determined that the current location is in the virtual vehicle.

The apparatus includes: a termination unit, configured to: after the virtual projection corresponding to the second virtual character is displayed, in response to a termination instruction triggered for the virtual vehicle, terminate the association relationship and cancel the display of the virtual projection corresponding to the second virtual character.

For a specific embodiment, refer to the example described in the foregoing information processing method. Details are not described herein again in this example.

In an exemplary embodiment, the apparatus includes at least one of the following:
a second display unit, configured to: after the virtual projection corresponding to the second virtual character is displayed, display character information corresponding to the second virtual character in response to a view instruction triggered for the virtual projection corresponding to the second virtual character;
a third display unit, configured to: after the virtual projection corresponding to the second virtual character is displayed, display an interactive interface corresponding to the second virtual character in response to an interaction instruction triggered for the virtual projection corresponding to the second virtual character, the interactive interface being configured to establish an information exchange channel between the first virtual character and the second virtual character; or
a fourth display unit, configured to: after the virtual projection corresponding to the second virtual character is displayed, play a battle screen of the second virtual character in the virtual game in response to a watch instruction triggered for the virtual projection corresponding to the second virtual character.

For a specific embodiment, refer to the example described in the foregoing information processing method. Details are not described herein again in this example.

According to still another aspect of the embodiments of this application, an electronic device configured to implement the information processing method described above is further provided. As shown in FIG. 17, the electronic device includes a memory 1702 and a processor 1704. The memory 1702 stores a computer program. The processor 1704 is configured to perform the blocks in any one of the foregoing method embodiments through the computer program.

In a possible implementation, in this embodiment, the foregoing electronic device may be located in at least one of a plurality of network devices in a computer network.

In a possible implementation, in this embodiment, the foregoing processor may be configured to perform the following blocks through the computer program:
S1: in a running process that a first virtual character participates in a current game task, obtaining a current location of the first virtual character in a scene of a virtual game, the first virtual character being a virtual character controlled by a client, and the current game task being a task in the virtual game; and
S2: displaying a virtual projection corresponding to a second virtual character if it is determined that the current location matches a virtual mobile device provided by the current game task, the second virtual character being a virtual character that meets a projection condition among virtual characters participating in the virtual game.

In a possible implementation, a person of ordinary skill in the art may understand that, the structure shown in FIG. 17 is only illustrative. The electronic device may alternatively be a terminal device such as a smartphone (such as an Android mobile phone or an iOS mobile phone), a tablet computer, a palmtop computer, a mobile Internet device (MID), or a PAD. FIG. 17 does not constitute a limitation on the structure of the foregoing electronic device. For example, the electronic device may further include more or fewer components (for example, a network interface) than those shown in FIG. 17, or has a configuration different from that shown in FIG. 17.

The memory 1702 may be configured to store a software program and a module, for example, a program instruction/module corresponding to the information processing method and apparatus in the embodiments of this application. The processor 1704 runs the software program and the module that are stored in the memory 1702 to perform various function applications and data processing, that is, to implement the foregoing information processing method. The memory 1702 may include a high-speed random access memory, and may also include a non-volatile memory, for example, one or more magnetic storage apparatuses, a flash memory, or another non-volatile solid-state memory. In some embodiments, the memory 1702 may further include memories remotely disposed relative to the processor 1704, and the remote memories may be connected to a terminal through a network. Examples of the network include, but are not limited to, the Internet, an intranet, a local area network (LAN), a mobile communication network, and a combination thereof. The memory 1702 may be specifically configured to store a current location, a virtual projection, and other information, but is not limited thereto. In an example, as shown in FIG. 17, the memory 1702 may include, but is not limited to, the obtaining unit 1602 and the first display unit 1604 in the foregoing information processing apparatus. In addition, the memory 1702 may further include, but is not limited to, other modules and units in the foregoing information processing apparatus. Details are not described again in this example.

In a possible implementation, a transmission apparatus 1706 is configured to receive or send data through a network. Specific examples of the foregoing network may include a wired network and a wireless network. In an example, the transmission device 1706 includes a network interface controller (NIC). The NIC may be connected to another network device and a router by using a network cable, so as to communicate with the Internet or a LAN. In an example, the transmission device 1706 is a radio frequency (RF) module, which communicates with the Internet in a wireless manner.

In addition, the foregoing electronic device further includes: a display 1708, configured to display the current location, the virtual projection, and other information; and a connection bus 1710, configured to connect the various modules and components in the electronic device.

In other embodiments, the foregoing terminal device or server may be a node in a distributed system. The distributed system may be a blockchain system. The blockchain system may be a distributed system formed by connecting a plurality of nodes through network communication. A peer-to-peer (P2P) network can be constituted between nodes. A computing device in any form, for example, an electronic device such as a server or a terminal can become one node in the blockchain system by joining the P2P network.

According to one aspect of this application, a computer program product is provided, including a computer program, the computer program including program code configured for performing the methods shown in the flowcharts. In such an embodiment, the computer program may be downloaded and installed from the network through a communication part, and/or may be installed from a removable medium. When the computer program is executed by a central processing unit (CPU), various functions provided in the embodiments of this application are performed.

The sequence numbers of the foregoing embodiments of this application are merely for description purpose but do not imply the preference among the embodiments.

A computer system of the electronic device shown is merely an example, and is not to constitute any limitation on functions and use scopes of the embodiments of this application.

The computer system includes the CPU, which can perform various suitable actions and processing according to a program stored in a read-only memory (ROM) or a program loaded from a storage part into a random access memory (RAM). The RAM further stores various programs and data required for system operations. The CPU, the ROM, and the RAM are connected to one another through a bus. An input/output (I/O) interface is also connected to the bus.

The following components are connected to the I/O interface: an input part including a keyboard, a mouse, or the like; an output part including a cathode ray tube (CRT), a liquid crystal display (LCD), a speaker, or the like; the storage part including a hard disk, or the like; and the communication part including a network interface card such as a LAN card or a modem. The communication part performs communication processing through a network such as the Internet. A driver is also connected to the I/O interface as required. A removable medium, such as a magnetic disk, an optical disk, a magneto-optical disk, or a semiconductor memory, is mounted on the drive as required, so that a computer program read therefrom is installed into the storage part as required.

Particularly, according to the embodiments of this application, the processes described in the various method flowcharts may be implemented as computer software programs. For example, this embodiment of this application includes a computer program product, including a computer program carried on a computer-readable medium. The computer program includes program code configured for performing the methods shown in the flowcharts. In such an embodiment, the computer program may be downloaded and installed from the network through a communication part, and/or may be installed from a removable medium. When the computer program is executed by the CPU, the various functions defined in the system of this application are performed.

According to one aspect of this application, a non-transitory computer-readable storage medium is provided. A processor of a computer device reads the computer program from the computer-readable storage medium. The processor executes the computer program to cause the computer device to perform the methods provided in the foregoing various optional implementations.

In a possible implementation, in this embodiment, a person of ordinary skill in the art can understand that, all or some blocks in the methods in the foregoing embodiments may be performed by a program instructing related hardware of a terminal device. The program may be stored in a computer-readable storage medium. The storage medium may include: a flash drive, a ROM, a RAM, a magnetic disk, an optical disc, and the like.

The sequence numbers of the foregoing embodiments of this application are merely for description purpose but do not imply the preference among the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or a part contributing to the related art, or all or a part of the technical solutions may be implemented in a form of a software product. The computer software product is stored in a storage medium and includes several instructions for instructing one or more computer devices (which may be a PC, a server, a network device, or the like) to perform all or some of block of the methods in the embodiments of this application.

In the foregoing embodiments of this application, descriptions of the embodiments have respective focuses. As for parts that are not described in detail in one embodiment, reference may be made to the relevant descriptions of the other embodiments.

In the several embodiments provided in this application, the disclosed client may be implemented in other manners. The apparatus embodiments described above are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electrical or other forms.

The units described as separate components may or may not be physically separated, and the components displayed as units may or may not be physical units, and may be located in one place or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

The foregoing descriptions are merely exemplary implementations of this application. A person of ordinary skill in the art may further make several improvements and modifications without departing from the principle of this application, and the improvements and modifications are also considered as falling within the protection scope of this application.

What is claimed is:

1. An information processing method performed by an electronic device comprising:
obtaining a current location of a first virtual character in a scene of a virtual game while the first virtual character participates in a current game task of the virtual game under control by a client;
determining that the current location matches a virtual vehicle provided by the current game task; and
displaying a virtual projection corresponding to a second virtual character that meets a projection condition among virtual characters participating in the virtual game.

2. The method according to claim 1, wherein the determining that the current location matches a virtual vehicle provided by the current game task comprises:
determining that the current location matches the virtual vehicle when the current location is in the virtual vehicle.

3. The method according to claim 1, wherein the displaying a virtual projection corresponding to a second virtual character comprises:
determining that the current location is in the virtual vehicle provided by the current game task at an initial stage; and
displaying a virtual projection corresponding to a first target virtual character in a first current screen on the client, the first target virtual character being the second virtual character set to enter a virtual scene of the current game task through the mobile vehicle.

4. The method according to claim 3, wherein the method further comprises:
before displaying the virtual projection corresponding to the first target virtual character in the first current screen on the client:
obtaining virtual projection resources held by virtual characters participating in the current game task; and
determining a virtual character corresponding to virtual projection resources whose resource amount is greater than or equal to a projection threshold as the first target virtual character meeting the projection condition.

5. The method according to claim 3, wherein the displaying a virtual projection corresponding to a first target virtual character in a first current screen on the client, the first target virtual character being the second virtual character set to enter a virtual scene of the current game task through the mobile vehicle comprises:
obtaining first battle information of the virtual characters participating in the current game task;
determining, according to the first battle information, the first target virtual character meeting the projection condition from the virtual characters participating in the current game task; and
displaying the virtual projection corresponding to the first target virtual character in the first current screen on the client.

6. The method according to claim 1, wherein the displaying a virtual projection corresponding to a second virtual character that meets a projection condition among virtual characters participating in the virtual game comprises:
determining that the current location is in the virtual vehicle is a control vehicle provided by the current game task for the first virtual character at a battle stage; and
displaying a virtual projection corresponding to a second target virtual character in a second current screen on the client, the second target virtual character being a virtual character meeting the projection condition among virtual characters participating in the current game task.

7. The method according to claim 1, wherein the displaying a virtual projection corresponding to a second virtual character that meets a projection condition among virtual characters participating in the virtual game comprises:
obtaining a first model corresponding to the second virtual character;
mounting the first model on a mesh of a second model corresponding to the virtual vehicle to obtain a mounted second model; and
rendering the mounted second model to display the virtual projection corresponding to the second virtual character.

8. The method according to claim 7, wherein the obtaining a first model corresponding to the second virtual character comprises:
creating an initial model of the second virtual character; and
mounting at least one projection component associated with the second virtual character to obtain the first model.

9. The method according to claim 1, wherein the method further comprises:
in response to a termination instruction triggered for the virtual vehicle, terminating an association relationship between the first virtual character and the virtual vehicle and canceling the display of the virtual projection corresponding to the second virtual character.

10. The method according to claim 1, wherein the method comprises at least one of the following:
displaying character information corresponding to the second virtual character in response to a view instruction triggered for the virtual projection corresponding to the second virtual character;
displaying an interactive interface corresponding to the second virtual character in response to an interaction instruction triggered for the virtual projection corresponding to the second virtual character; or
playing a battle screen of the second virtual character in the virtual game in response to a watch instruction triggered for the virtual projection corresponding to the second virtual character.

11. An electronic device, comprising a memory and a processor, the memory storing a computer program that, when executed by the processor, causes the electronic device to perform an information processing method including:
obtaining a current location of a first virtual character in a scene of a virtual game while the first virtual character participates in a current game task of the virtual game under control by a client;
determining that the current location matches a virtual vehicle provided by the current game task; and
displaying a virtual projection corresponding to a second virtual character that meets a projection condition among virtual characters participating in the virtual game.

12. The electronic device according to claim 11, wherein the determining that the current location matches a virtual vehicle provided by the current game task comprises:
determining that the current location matches the virtual vehicle when the current location is in the virtual vehicle.

13. The electronic device according to claim 11, wherein the displaying a virtual projection corresponding to a second virtual character comprises:
determining that the current location is in the virtual vehicle provided by the current game task at an initial stage; and
displaying a virtual projection corresponding to a first target virtual character in a first current screen on the client, the first target virtual character being the second virtual character set to enter a virtual scene of the current game task through the mobile vehicle.

14. The electronic device according to claim 13, wherein the method further comprises:
before displaying the virtual projection corresponding to the first target virtual character in the first current screen on the client:
obtaining virtual projection resources held by virtual characters participating in the current game task; and
determining a virtual character corresponding to virtual projection resources whose resource amount is greater than or equal to a projection threshold as the first target virtual character meeting the projection condition.

15. The electronic device according to claim 13, wherein the displaying a virtual projection corresponding to a first target virtual character in a first current screen on the client, the first target virtual character being the second virtual character set to enter a virtual scene of the current game task through the mobile vehicle comprises:
obtaining first battle information of the virtual characters participating in the current game task;
determining, according to the first battle information, the first target virtual character meeting the projection condition from the virtual characters participating in the current game task; and
displaying the virtual projection corresponding to the first target virtual character in the first current screen on the client.

16. The electronic device according to claim 11, wherein the displaying a virtual projection corresponding to a second virtual character that meets a projection condition among virtual characters participating in the virtual game comprises:
determining that the current location is in the virtual vehicle is a control vehicle provided by the current game task for the first virtual character at a battle stage; and
displaying a virtual projection corresponding to a second target virtual character in a second current screen on the client, the second target virtual character being a virtual character meeting the projection condition among virtual characters participating in the current game task.

17. The electronic device according to claim 11, wherein the displaying a virtual projection corresponding to a second virtual character that meets a projection condition among virtual characters participating in the virtual game comprises:
obtaining a first model corresponding to the second virtual character;
mounting the first model on a mesh of a second model corresponding to the virtual vehicle to obtain a mounted second model; and
rendering the mounted second model to display the virtual projection corresponding to the second virtual character.

18. The electronic device according to claim 11, wherein the method further comprises:
in response to a termination instruction triggered for the virtual vehicle, terminating an association relationship between the first virtual character and the virtual vehicle and canceling the display of the virtual projection corresponding to the second virtual character.

19. The electronic device according to claim 11, wherein the method comprises at least one of the following:
displaying character information corresponding to the second virtual character in response to a view instruction triggered for the virtual projection corresponding to the second virtual character;
displaying an interactive interface corresponding to the second virtual character in response to an interaction instruction triggered for the virtual projection corresponding to the second virtual character; or
playing a battle screen of the second virtual character in the virtual game in response to a watch instruction triggered for the virtual projection corresponding to the second virtual character.

20. A non-transitory computer-readable storage medium having a computer program stored therein, the computer program, when run by a processor of an electronic device, causing the electronic device to perform an information processing method including:
obtaining a current location of a first virtual character in a scene of a virtual game while the first virtual character participates in a current game task of the virtual game under control by a client;
determining that the current location matches a virtual vehicle provided by the current game task; and
displaying a virtual projection corresponding to a second virtual character that meets a projection condition among virtual characters participating in the virtual game.
